(19) United States
(12) Patent Application Publication
(10) Pub. No.: US 2016/0353079 A1
(43) Pub. Date: Dec. 1, 2016

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Keiichi Sawada, Kawasaki-shi (JP)

(21) Appl. No.: 15/165,008

(22) Filed: May 26, 2016

(30) Foreign Application Priority Data
May 29, 2015 (JP) 2015-110214

(51) Int. Cl. H04N 13/00; H04N 13/04; G06T 5/00

(52) U.S. Cl. CPC H04N 13/0033; G06T 5/002; H04N 13/0018; H04N 13/0484

(57) ABSTRACT

An image processing apparatus is configured to obtain multi-viewpoint image data indicating a plurality of images acquired in a case where the same object is viewed from different viewpoints, perform, on the multi-viewpoint image data, blurring processing which increases a size of blur of the plurality of images according to a magnitude of a parallax between the plurality of images, and generate, using the multi-viewpoint image data on which the blurring processing has been performed, stereoscopic image data used for stereoscopic vision of the object.

### BACKGROUND OF THE INVENTION

### Field of the Invention

The present disclosure generally relates to image processing and, more particularly, to an image processing apparatus, an image processing method, storage medium, and to a method for generating image data to be used for performing stereoscopic display.

### Description of the Related Art

There is an imaging apparatus which performs imaging from a plurality of viewpoints. Japanese Patent Application Laid-Open No. 2012-93779 discusses a stereo camera having two imaging units disposed on a body and thus being capable of obtaining an image viewed from both right and left viewpoints. A stereoscopic image for performing stereoscopic vision, to be displayed on a three-dimensional (3D) display, can be generated from right and left viewpoint images obtained using the stereo camera.

Further, Japanese Patent Application Laid-Open No. 2013-115532 discusses a plenoptic camera capable of obtaining a multi-viewpoint image as when viewed from a plurality of different viewpoints. The multi-viewpoint image is obtained by focusing light which has passed through an imaging lens on a different pixel in an image sensor for each region on the image lens the light has passed through. The stereoscopic image can also be generated from the image obtained by the plenoptic camera similarly as the stereo camera. The multi-viewpoint image obtained by the plenoptic camera is an image captured using a plurality of continuous partial regions on the imaging lens as an aperture. There is thus continuity between each of point images corresponding to the same object. As a result, in the case where the stereoscopic image is generated by combining the images of a plurality of viewpoints, the point images corresponding to the images of each viewpoint are combined. When the stereoscopic image is then viewed without using 3D glasses, the point images corresponding to the images of each viewpoint are perceived as one collective point image. In other words, when the stereoscopic image generated from the images captured by the plenoptic camera is viewed without using the 3D glasses, the image can be viewed as a two-dimensional (2D) image without a feeling of discomfort.

Furthermore, Japanese Patent Application Laid-Open No. 2013-115532 discusses a technique for enlarging parallaxes between the images obtained by the plenoptic camera by performing image processing so that a stereoscopic effect of the stereoscopic image is increased.

On the other hand, there is no continuity between the point images of each of the viewpoint images captured by the stereo camera discussed in Japanese Patent Application Laid-Open No. 2012-93779. As a result, if the stereoscopic image generated from the images captured by the stereo camera is viewed without using the 3D glasses, the point images of the right and left viewpoint images corresponding to the same object are perceived as different point images. There is thus a feeling of discomfort in viewing the stereoscopic image. Further, if the stereoscopic image is generated from the images captured by the plenoptic camera by enlarging the parallaxes between each of the viewpoint images using the technique according to Japanese Patent Application Laid-Open No. 2013-115532, there is a feeling of discomfort when the image is viewed without the 3D glasses. The feeling of discomfort is caused by the loss of continuity between the point images corresponding to each of the viewpoint images.

### SUMMARY OF THE INVENTION

The present disclosure is directed to a method for reducing a feeling of discomfort when a stereoscopic image is viewed as a two-dimensional image.

According to an aspect of the present disclosure, an image processing apparatus includes at least one processor coupled to at least one memory, the at least one processor being programmed to obtain multi-viewpoint image data indicating a plurality of images acquired in a case where the same object is viewed from different viewpoints, perform, on the multi-viewpoint image data, blurring processing which increases a size of blur of the plurality of images according to a magnitude of a parallax between the plurality of images, and generate, using the multi-viewpoint image data on which the blurring processing has been performed, stereoscopic image data used for stereoscopic vision of the object.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image processing apparatus according to a first exemplary embodiment of the present disclosure.

FIG. 2 illustrates an internal configuration of an imaging apparatus according to the first exemplary embodiment.

FIG. 3 illustrates functions of a plenoptic camera.

FIG. 4 illustrates relations between a base line length, a size of a point image, and a parallax of the plenoptic camera.

FIGS. 5A, 5B, and 5C illustrate examples of the point images captured by the plenoptic camera.

FIGS. 6A, 6B, and 6C illustrate effects of performing a parallax enlargement process on the point images.

FIG. 7 is a block diagram illustrating a functional configuration of the image processing apparatus according to the first exemplary embodiment.

FIG. 8 is a flowchart illustrating a process performed by the image processing apparatus according to the first exemplary embodiment.

FIG. 9 is a flowchart illustrating blurring processing performed by the image processing apparatus according to the first exemplary embodiment.

FIG. 10 illustrates an outline of the blurring processing performed by the image processing apparatus according to the first exemplary embodiment.

FIGS. 11A, 11B, 11C, 11D, 11E, and 11F illustrate results of the blurring processing performed in the image processing apparatus according to the first exemplary embodiment.

FIGS. 12A, 12B, 12C, 12D, 12E, 12F, 12G, 12H, and 12I illustrate examples of an stereoscopic image.

FIG. 13 illustrates an internal configuration of an imaging apparatus according to a second exemplary embodiment of the present disclosure.

FIGS. 14A, 14B, and 14C illustrate examples of the point images captured by a stereo camera.

FIGS. 15A and 15B illustrate results of the blurring processing performed by the image processing apparatus according to the second exemplary embodiment.

### DESCRIPTION OF THE EMBODIMENTS

An example of generating a stereoscopic image from images in which a parallax between right and left viewpoint images obtained using a plenoptic camera is enlarged will be described below according to a first exemplary embodiment. According to the present exemplary embodiment, blurring processing to be described below is performed on the right and left viewpoint images of which the parallax has been enlarged. The processed images are then used for generating the stereoscopic image. As a result, the stereoscopic image in which there is no feeling of discomfort even when viewed as a two-dimensional image can be generated. According to the present exemplary embodiment, the stereoscopic image indicates an image used for performing a line-by-line method which alternately displays a right viewpoint image and a left viewpoint image for each line of the image. Further, the stereoscopic image indicates an image used for performing a stereoscopic display method such as time division display which switches between and displays the right viewpoint image and the left viewpoint image at high speed. If a viewer views the stereoscopic image without using the 3D glasses, the viewer perceives a two-dimensional image in which the right viewpoint image and the left viewpoint image are added together.

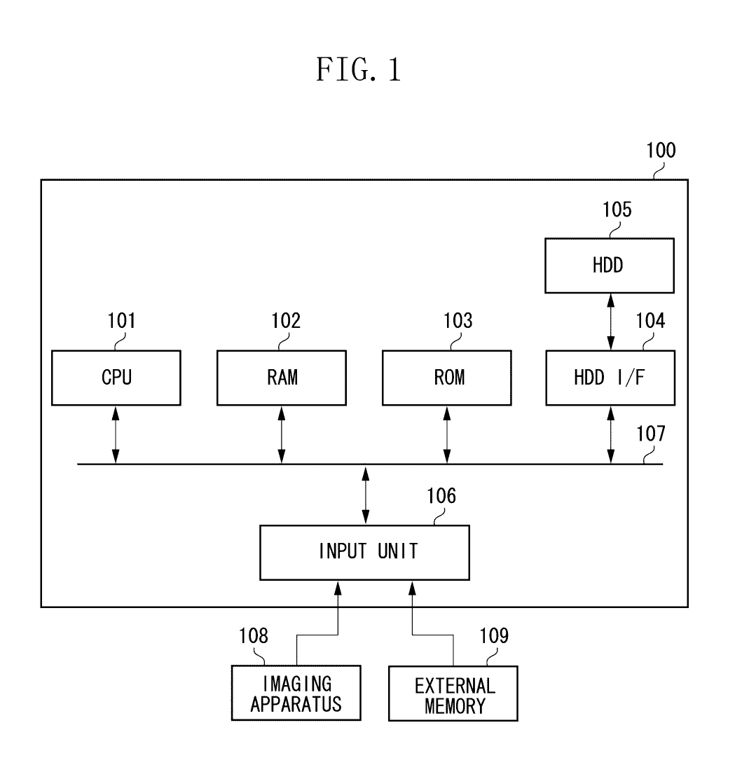

FIG. 1 illustrates an example of a configuration of the image processing apparatus according to the present exemplary embodiment. Referring to FIG. 1, an image processing apparatus 100 includes a central processing unit (CPU) 101, which may include one or more processors and one or more memories, a random access memory (RAM) 102, a read-only memory (ROM) 103, a hard disk drive interface (HDD I/F) 104, an HDD 105, an input unit 106, and a system bus 107. Further, the image processing apparatus 100 is connected to an imaging apparatus 108 and an external memory 109. As used herein, the term “unit” generally refers to any combination of software, firmware, hardware, or other component, such as circuitry, that is used to effectuate a purpose.

The CPU 101 includes at least one processor which, using the RAM 102 as a work memory, executes a program stored in the ROM 103 and collectively controls each of the configurations to be described below via the system bus 107. The programs executed by the CPU 101 realize various processes to be described below.

The HDD I/F 104, e.g., an interface such as a serial advanced technology attachment (SATA), connects to the HDD 105 as a secondary storage device. The CPU 101 is capable of reading data from and writing data on the HDD 105 via the HDD I/F 104. Other storage devices such as an optical disk drive may be used as the secondary storage device instead of the HDD.

The input unit 106 is a serial bus interface such as a universal serial bus (USB) or an Institute of Electrical and Electronic Engineers (IEEE) 1394. The CPU 101 is capable of obtaining data from the imaging apparatus 108 and the external memory 109 (e.g., the hard disk, a memory card, a compact flash (CF) card, a SanDisk (SD) card, or a USB memory) via the input unit 106. According to the present exemplary embodiment, the imaging apparatus 108 is the plenoptic camera. The plenoptic camera will be described in detail below. Since other elements included in the image processing apparatus 100 are not a focus of the present exemplary embodiment, description thereof will be omitted.

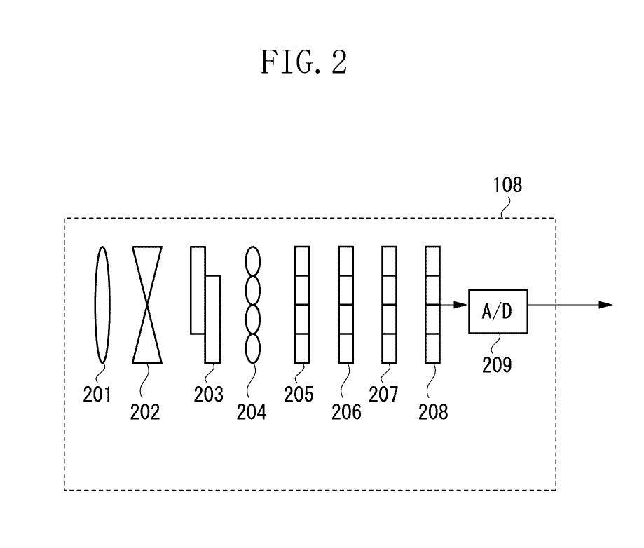

FIG. 2 illustrates an internal configuration of the imaging apparatus 108 (i.e., the plenoptic camera) according to the first exemplary embodiment. Referring to FIG. 2, the imaging apparatus 108 includes a main lens 201, an aperture 202, a shutter 203, a microlens array 204, an optical low pass filter 205, an infrared radiation (iR) cut filter 206, a color filter 207, an image sensor 208, and an analog/digital (A/D) conversion unit 209. Hereinafter, the main lens 201 will be described as a single lens. However, the main lens 201 is actually configured of a plurality of lenses such as a zoom lens and a focus lens. Depth of field and an incident light amount of the imaging apparatus 108 are adjustable by adjusting the aperture 202. The microlens array 204 is different from a general focusing microlens for focusing light. In the case of the general microlens for focusing light, one microlens (e.g., a convex lens) is arranged for each pixel in the image sensor. However, in the case of the microlens array 204, one microlens is arranged with respect to a plurality of pixels (e.g., one microlens to two pixels). A lens array having the above-described function will be referred to as a microlens array regardless of the size of each lens in the microlens array 204.

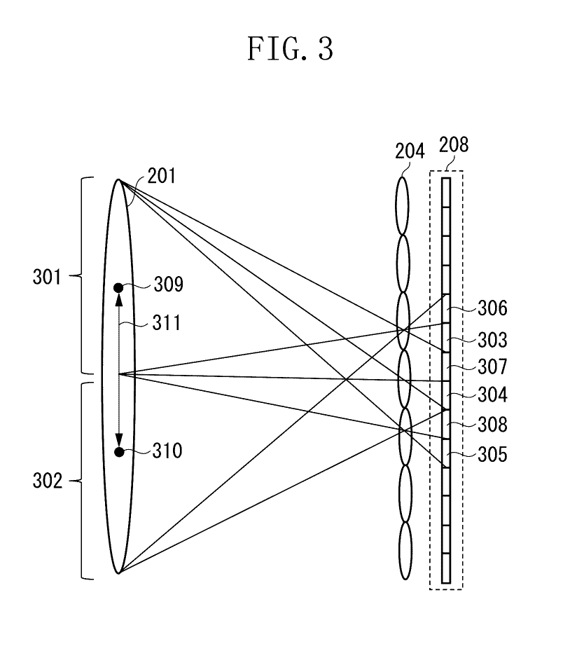

FIG. 3 illustrates functions of the imaging apparatus 108 (i.e., the plenoptic camera) according to the first exemplary embodiment. Referring to FIG. 3, the imaging apparatus 108 includes a function for focusing a light flux which passes through a region 301 and a light flux which passes through a region 302, among the regions of the main lens 201, on different pixels. According to the example illustrated in FIG. 3, the light flux which passes through the region 301 is focused on pixels 303, 304, and 305 (i.e., right (R) pixels), and the light flux which passes through the region 302 is focused on pixels 306, 307, and 308 (i.e., left (L) pixels). FIG. 3 only illustrates the example of the light fluxes entering the pixels 303, 304, 305, 306, 307, and 308. However, the R pixels and the L pixels similarly exist with respect to other pixels in the image sensor 208. If an image is generated by only collecting the output from the R pixels, an image (i.e., the right viewpoint image) in which a center 309 of the region 301 is the viewpoint can be generated. If an image is generated by only collecting the output from the L pixels, an image (i.e., the left viewpoint image) in which a center 310 of the region 302 is the viewpoint can be generated. As described above, the images corresponding to the plurality of different viewpoints can be obtained using the plenoptic camera. Hereinafter, the right viewpoint image and the left viewpoint image will be collectively referred to as the right and left viewpoint images. Further, a distance 311 between the center 309 of the region 301 and the center 310 of the region 302 will be referred to as a base line length. Light intensity of each of the light fluxes which have passed through respective positions on the main lens 201 and focused on the pixels is different depending on the position where the light flux has passed through on the main lens 201. A centroid of a light intensity distribution may thus be used as the viewpoint instead of the center of the region of the main lens. Hereinafter, the center of each region of the main lens will be described as the viewpoint of each image. However, the present disclosure is not limited thereto. Furthermore, the plenoptic camera which discriminates the light beams of two partial regions of the main lens will described below as an example. However, the present disclosure is not limited thereto. For example, the present disclosure is applicable to the plenoptic camera which discriminates the light beams of more than two partial regions of the main lens. In such a case, the images corresponding to each of the partial regions may be superimposed to generate the right and left viewpoint images. The images corresponding to two partial regions selected from all partial regions may also be used as the right and left viewpoint images.

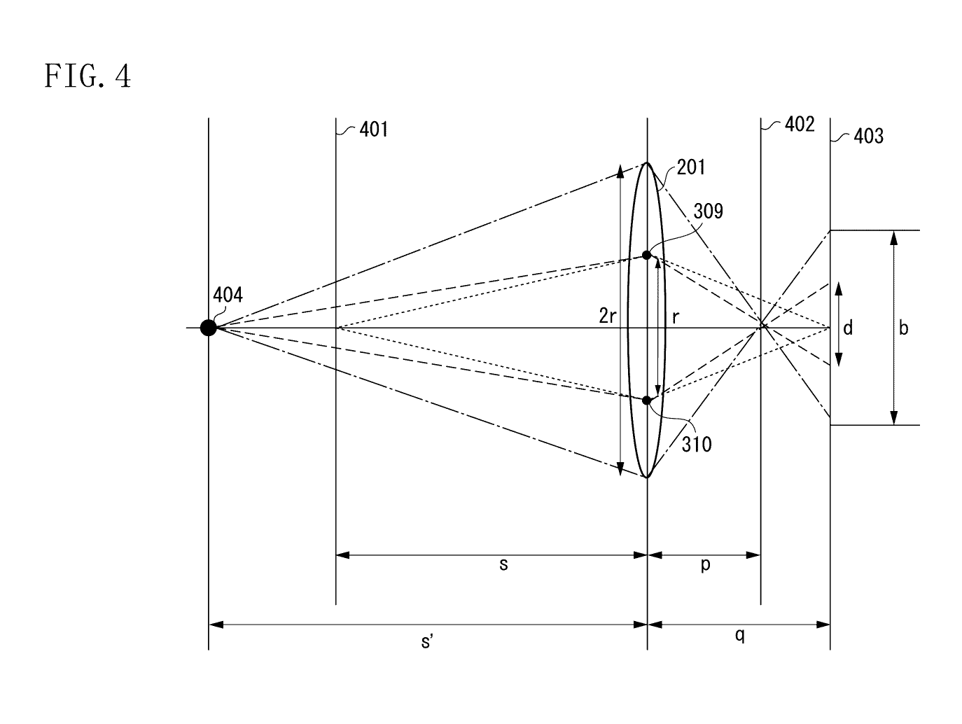

FIG. 4 illustrates relations between the base line length between the right and left viewpoint images captured by the imaging apparatus 108, a size of the point image for each image, and a parallax between each of the images. Referring to FIG. 4, a plane 401 indicates an object side focal plane, a plane 402 indicates a camera side focal plane, a plane 403 indicates a sensor plane, and a point 404 indicates an object point. The base line length (i.e., the distance between the viewpoint 309 and the viewpoint 310) is indicated as r, and a focal length as f. Further, the distance between the main lens 201 and the object side focal plane 401 is indicated as s, the distance between the main lens 201 and the object point 404 as s′, the distance between the main lens 201 and the camera side focal plane 402 as p, and the distance between the main lens 201 and the sensor plane 403 as q. In such a case, a parallax d between the right and left viewpoint images (i.e., the distance between the pixel to which the light from the object point 404 enters via the viewpoint 309 and the pixel to which the light from the object point 404 enters via the viewpoint 310) is expressed as equation (1).

$$d = \begin{matrix}r ( p - q ) \\ p\end{matrix} \\ \begin{matrix}1 \\ s\end{matrix} + \begin{matrix}1 \\ q\end{matrix} = \begin{matrix}1 \\ {s}^{′}\end{matrix} + \begin{matrix}1 \\ p\end{matrix} = \begin{matrix}1 \\ f\end{matrix} \qquad ( 1 )$$

Further, a size b of the point image of the object point 404 on the sensor plane 403 is expressed as equation (2).

b=2d (2)

Since the base line length r of the imaging apparatus 108 (i.e., the plenoptic camera) is limited by the size of the main lens 201, the base line length r of the plenoptic camera is often less than the base line length of the stereo camera. The equations (1) and (2) indicate that the parallax d is proportional to the base line length r. In general, the stereoscopic effect (i.e., a projecting amount or depth) of the stereoscopic image when the right and left viewpoint images are displayed on the 3D display decreases as the parallax d decreases. The stereoscopic effect of the stereoscopic image obtained using the imaging apparatus 108 is thus small. To solve such an issue, according to the present exemplary embodiment, the image processing apparatus 100 enlarges the parallax (hereinafter referred to as “performs a parallax enlargement process”) between the right and left viewpoint images by performing image processing. The parallax may be enlarged using various known techniques. For example, pixel positions corresponding to the same point on the object in both the right and left viewpoint images are derived by performing stereo matching. The positions of the pixels are then moved so that deviation between the derived pixel positions increases. Since the parallax enlargement process is not a focus of the present disclosure, further description will be omitted.

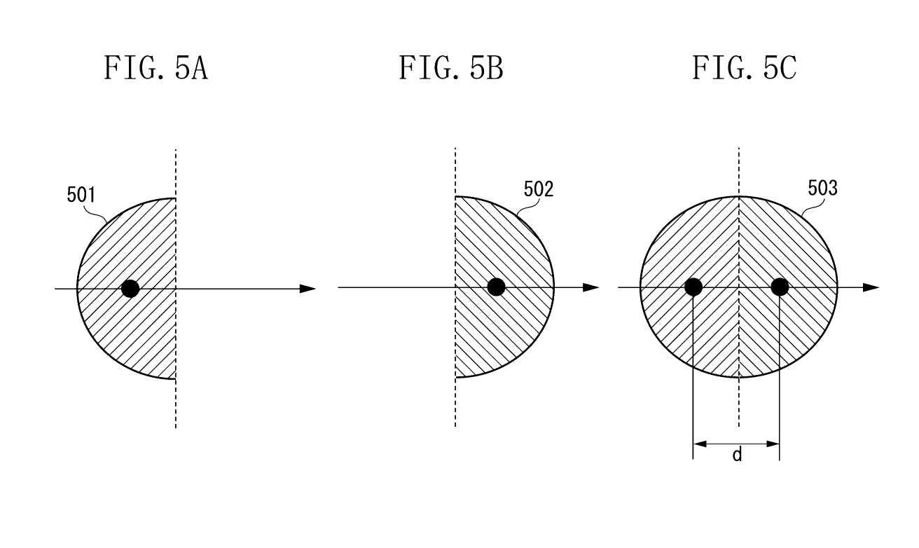

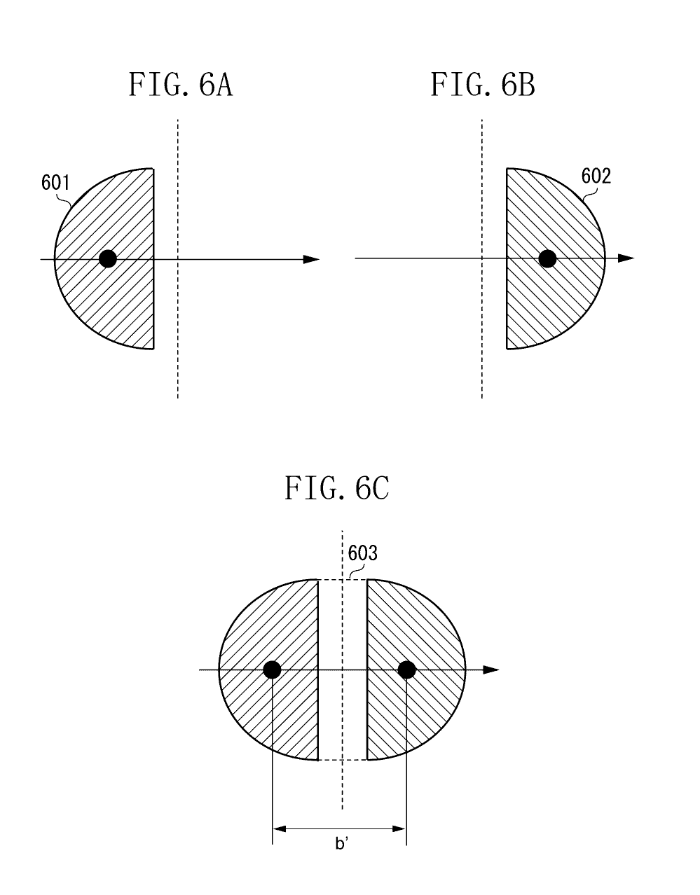

The effect of performing the parallax enlargement process on the stereoscopic image will be described with reference to FIGS. 5A, 5B, 5C, 6A, 6B, and 6C. FIGS. 5A, 5B, and 5C are schematic diagrams illustrating point image distributions captured by the imaging apparatus 108 according to the first exemplary embodiment. More specifically, FIG. 5A illustrates the point image distribution of a right viewpoint image and FIG. 5B illustrates the point image distribution of a left viewpoint image. If the right and left viewpoint images having the point images illustrated in FIGS. 5A and 5B are combined and a stereoscopic image is generated, the point image illustrated in FIG. 5A and the point image illustrated in FIG. 5B become combined and displayed on the same image. The viewer then perceives the point image illustrated in FIG. 5C. In such a case, since the point images corresponding to one object point are perceived as one point image, the viewer can view the stereoscopic image as the two-dimensional image without a feeling of discomfort even when not using the 3D glasses. Such a result is obtained due to an image region corresponding to the point image of the right viewpoint image and an image region corresponding to the point image of the left viewpoint image being adjacent to each other. Hereinafter, a state in which there is no space between the image regions corresponding to the two point images so that the one continuous point image is obtained when the images are combined will be referred to as a state in which “there is continuity (of the point images)”.

FIGS. 6A, 6B, and 6C are schematic diagrams illustrating the point distributions of the right and left viewpoint images on which the parallax enlargement process has been performed. More specifically, FIG. 6A illustrates the point image distribution of the right viewpoint image and FIG. 6B illustrates the point image distribution of the left viewpoint image. Referring to FIGS. 6A and 6B, the images are moved to the positions shifted outwards from the center of an optical axis. If such right and left viewpoint images are combined and a stereoscopic image is generated, the point image illustrated in FIG. 6A and the point image illustrated in FIG. 6B become combined and perceived as the point image illustrated in FIG. 6C. In such a case, if the stereoscopic image is viewed as the two-dimensional image, the point image corresponding to one object point is perceived as two separate point images, so that there is a feeling of discomfort for the viewer. Such a result is caused by the loss of continuity between the point images of the right and left viewpoint images due to performing the parallax enlargement process.

To solve the above-described issue, according to the first exemplary embodiment, the blurring processing to be described below is executed on the images obtained by performing the parallax enlargement process on the right and left viewpoint images captured by the plenoptic camera. The stereoscopic image viewable as the two-dimensional image without a feeling of discomfort can then be generated. Such a method will be described below. Hereinafter, the image which “is viewable as the two-dimensional image” is the image which “is viewable in a state in which the effect of an artifact caused by the deviation between the right and left viewpoint images is small”.

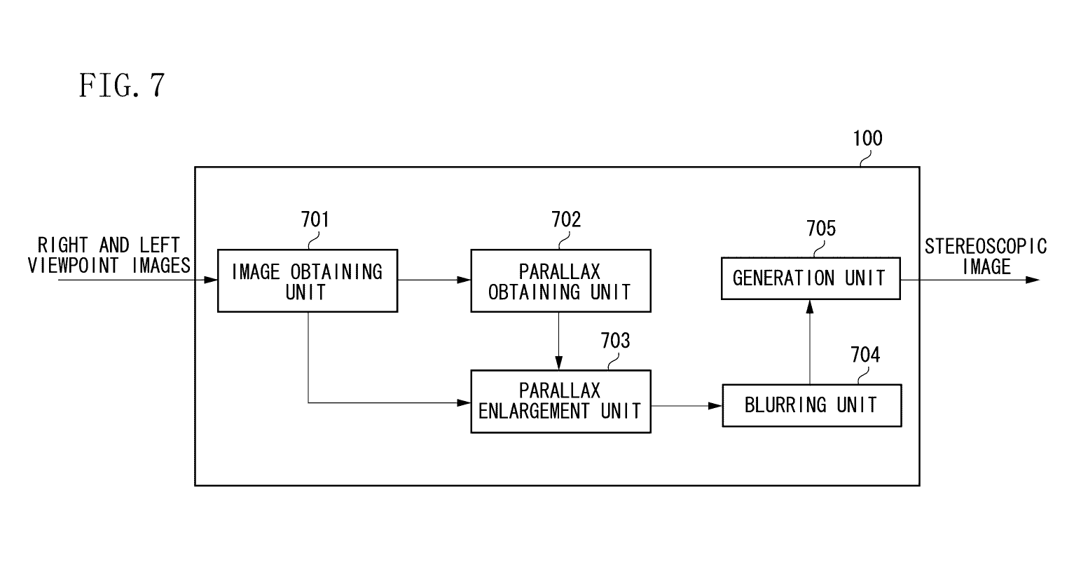

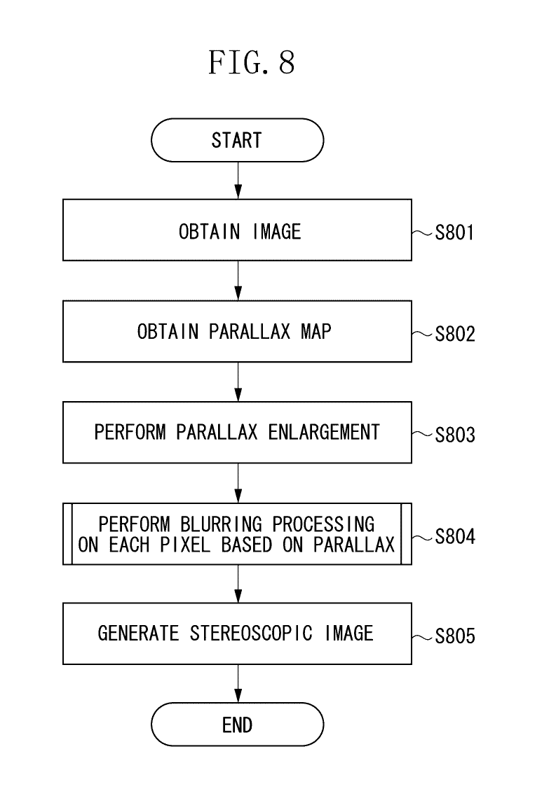

The process performed by the image processing apparatus 100 according to the first exemplary embodiment will be described below with reference to the block diagram illustrated in FIG. 7 and the flowchart illustrated in FIG. 8. According to the present exemplary embodiment, the CPU 101 in the image processing apparatus 100 uses the RAM 102 as the work memory and executes the programs stored in the ROM 103, and thus performs the process illustrated in FIG. 8 as the block illustrated in FIG. 7. The configuration of the image processing apparatus 100 is not limited thereto and may include dedicated processing circuits corresponding to each block illustrated in FIG. 7.

In step S801 illustrated in FIG. 8, an image obtaining unit 701 illustrated in FIG. 7 obtains the right and left viewpoint images captured by the imaging apparatus 108. The image obtaining unit 701 then outputs the obtained right and left viewpoint images to a parallax obtaining unit 702 and a parallax enlargement unit 703.

In step S802, the parallax obtaining unit 702 obtains a parallax map indicating a magnitude of the parallax for each pixel in the right and left viewpoint images input from the image obtaining unit 701. Various methods may be used for obtaining the parallax map. For example, the imaging apparatus 108 may include a light source for irradiating an object with light and a sensor for receiving the light reflected by the object. The imaging apparatus 108 may then estimate a distance to the object based on time required for receiving the irradiated light, and determine the parallax from the obtained distance information. Further, the parallax may be determined by performing block matching between the right and left viewpoint images. According to the present exemplary embodiment, the parallax obtaining unit 702 performs the block matching between the right and left viewpoint images and obtains the parallax map. The parallax obtaining unit 702 generates the parallax map corresponding to the left viewpoint image and the parallax map corresponding to the right viewpoint image, and outputs the generated maps to the parallax enlargement unit 703. According to the present exemplary embodiment, the generated parallax maps store for each pixel a value of the difference between the pixel position thereof and the position at which the corresponding pixel in the other viewpoint image exists. For example, if the positions of the pixels corresponding to one point on the object are (10, 50) in the left viewpoint image and (20, 50) in the right viewpoint image, a value +10 is stored in the pixel position (10, 50) on the parallax map of the left viewpoint image. Further, a value −10 is stored in the pixel position (20, 50) on the parallax map of the right viewpoint image.

In step S803, the parallax enlargement unit 703 performs, based on the parallax maps input from the parallax obtaining unit 702, the parallax enlargement process on the right and left viewpoint images input from the image obtaining unit 701. According to the present exemplary embodiment, the parallax enlargement process is a process for enlarging the magnitude of the parallax between the right and left viewpoint images for each pixel by a predetermined magnification. It is assumed that the value of the parallax stored in the parallax map of the left viewpoint image is d, and the value of the parallax stored in the parallax map of the right viewpoint image is −d. In such a case, if the magnitude of the parallax between the right and left viewpoint images is to become a|d| (wherein a is a real number greater than 1), the following is performed. The pixel position of the pixel in the left viewpoint image is shifted by −(a−1)d/2 pixels, and the pixel position of the pixel in the left viewpoint image is shifted by +(a−1)d/2 pixels. The parallax enlargement unit 703 performs the parallax enlargement process on the right and left viewpoint images by shifting each pixel, and outputs the processed images to a blurring unit 704. According to the present exemplary embodiment, the parallax enlargement unit 703 also reflects the result of the parallax enlargement process in the two parallax maps corresponding to the right and left viewpoint images. In other words, the parallax enlargement unit 703 shifts the pixel positions in the parallax maps similarly as in the right and left viewpoint images, so that the pixel value of the pixel is changed from d to ad. The parallax enlargement unit 703 also outputs the parallax maps in which the parallax enlargement result has been reflected to the blurring unit 704.

In step S804, the blurring unit 704 performs the blurring processing on the right and left viewpoint images, on which the parallax enlargement process has been performed, input from the parallax enlargement unit 703. The process will be described in detail below. The blurring unit 704 then outputs the right and left viewpoint images on which the blurring processing has been performed to a generation unit 705.

In step S805, the generation unit 705 uses the right and left viewpoint images, on which the blurring processing has been performed, input from the blurring unit 704, and generates a stereoscopic image. The process then ends. Various known techniques may be used for generating the stereoscopic image. According to the present exemplary embodiment, the generation unit 705 generates the stereoscopic image using the line-by-line method which combines the right and left viewpoint images and thus switches between the right viewpoint image and the left viewpoint image for each pixel line of the image. However, the stereoscopic image may be generated using other methods. Since the generation method of the stereoscopic image is not a focus of the present disclosure, description will be omitted.

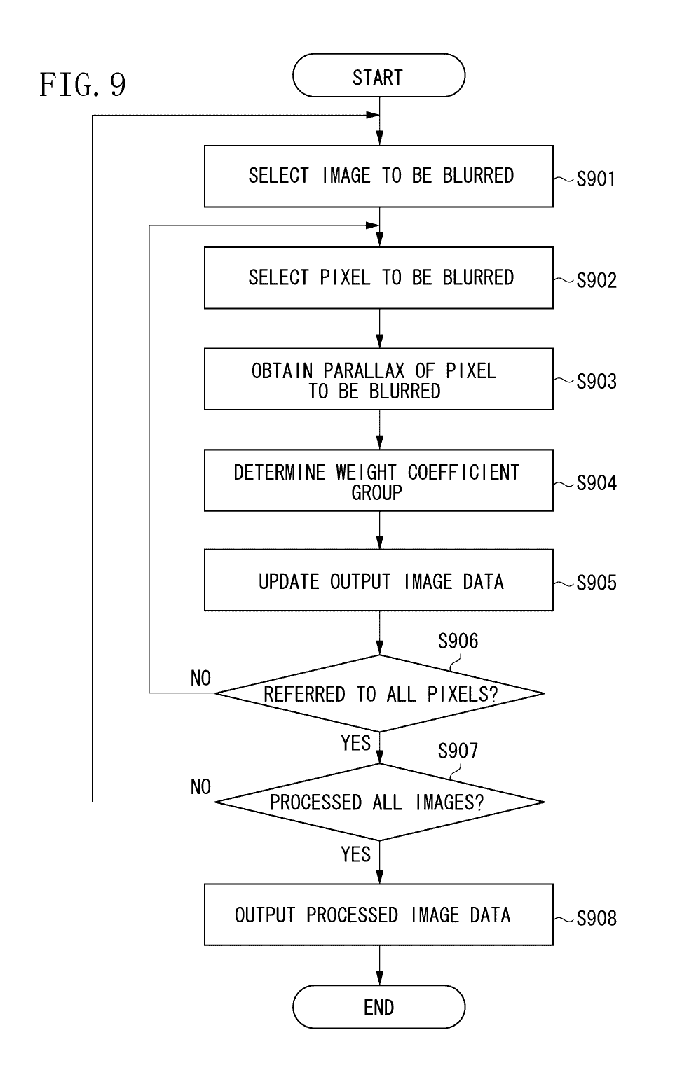

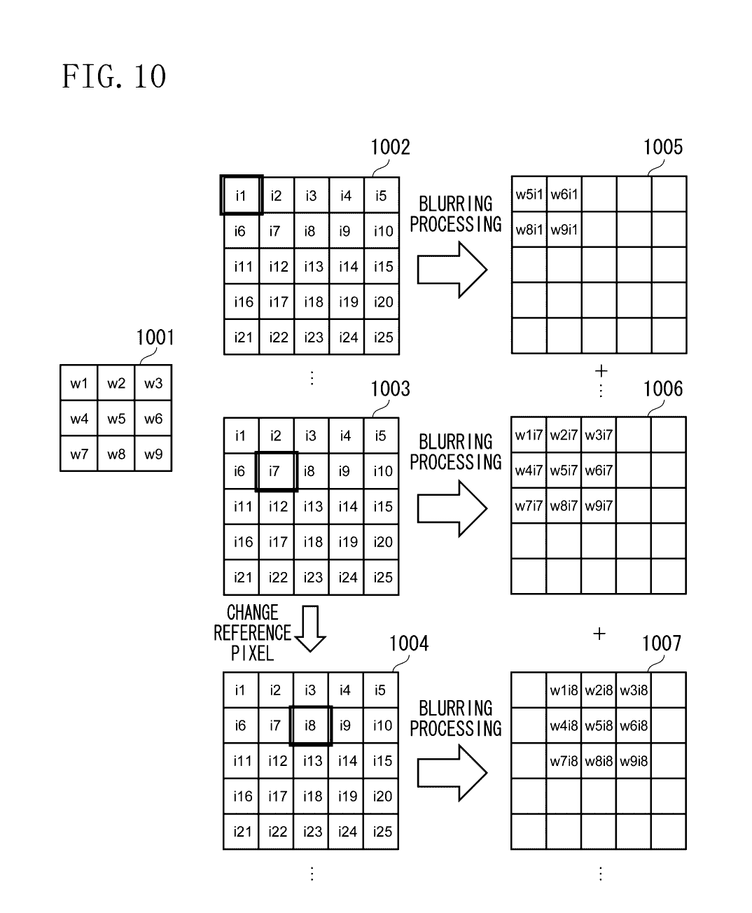

The blurring processing (in step S804) performed by the blurring unit 704 will be described in detail below. FIG. 9 is a flowchart illustrating a process performed by the blurring unit 704, and FIG. 10 illustrates an outline of the blurring processing performed by the blurring unit 704. The outline of the blurring processing performed by the blurring unit 704 will be described below with reference to FIG. 10. According to the present exemplary embodiment, the blurring processing is performed so that the pixel value of each pixel in image data to be blurred (hereinafter referred to as input image data) is blurred and spread to surrounding pixels. Referring to FIG. 10, a coefficient group 1001 includes weight coefficients used for blurring each pixel. The weight coefficients are set for each of 3 by 3 pixels in which a reference pixel is at the center. Each weight coefficient is determined according to the distance from the center pixel so that the sum becomes 1. The process for blurring each pixel is performed as follows. The pixel value of each pixel which has been referred to is multiplied by the weight coefficient indicated in the coefficient group 1001. Each obtained value is then added to the each pixel value of the corresponding pixel in the image data of the blurring result (hereinafter referred to as output image data). The process will be described below with reference to a specific example.

Referring to FIG. 10, images 1002, 1003, and 1004 are images configured of 5 by 5 pixels. Each pixel is sequentially numbered as pixel 1 to pixel 25 from the upper left pixel towards a lower right direction in the image 1002. It is assumed that pixel values i1, i2, i3, . . . , and i25 are respectively stored in the pixels from pixel 1 to pixel 25. The image 1002 indicates a case where the pixel 1 is referred to as the pixel subject to the blurring processing. As a result of performing the blurring processing, an image 1005 is obtained, and the pixel values obtained by multiplying the weight coefficients to the pixel value i1 are assigned to the pixels 1, 2, 6, and 7 as the pixel values of the output image data. In other words, the pixel value of the pixel to be blurred is allocated to the plurality of pixels including the pixel to be blurred at a predetermined ratio. Similarly, the image 1003 indicates a case where pixel 7 is referred to as the pixel to be blurred. As a result of performing the blurring processing, an image 1006 is obtained, and the pixel values obtained by multiplying the weight coefficients to the pixel value i7 are assigned to the pixels 1, 2, 3, 6, 7, 8, 11, 12, and 13 as the pixel values of the output image data. Similarly, the image 1004 indicates a case where pixel 8 is referred to as the pixel to be blurred. As a result of performing the blurring processing, an image 1007 is obtained, and the pixel values obtained by multiplying the weight coefficients to the pixel value i8 are assigned to the pixels 2, 3, 4, 7, 8, 9, 12, 13, and 14 as the pixel values of the output image data. The sum of the results obtained by similarly performing the blurring processing on each of the pixels from pixel 1 to pixel 25 becomes the output image data. The values of the weight coefficients and the size of spreading used for performing the blurring processing are changed as appropriate based on the magnitude of a parallax corresponding to each pixel. By performing such processing, an appropriate blurring amount is set for each corresponding parallax of the object, and a natural image is obtained after the blurring processing has been performed.

The blurring processing performed by the blurring unit 704 will be described in detail below with reference to the flowchart illustrated in FIG. 9.

In step S901, the blurring unit 704 selects the image data on which the blurring processing is to be performed from the input left and right viewpoint image data. The blurring processing may be performed in any order. According to the present example, the blurring processing is first performed on the left viewpoint image.

In step S902, the blurring unit 704 selects the pixel to be blurred from the image data selected in step S901. In step S903, the blurring unit 704 refers to the parallax map input from the parallax enlargement unit 703 and obtains the value of the parallax corresponding to the pixel to be blurred.

In step S904, the blurring unit 704 determines, based on the value of the parallax obtained in step S903, the weight coefficient to be used for performing the blurring processing on the pixel to be blurred. According to the present exemplary embodiment, the coefficient group used for a known blurring filter is directly usable. For example, a coefficient h of a Gaussian filter indicated by equation (3) is usable.

h(x, y)=C exp{−(x²+y²)/(d/2)²} (3)

In equation (3), x and y indicate a pixel position in the image in which the pixel to be blurred is set as an origin, d indicates the value of the parallax corresponding to the pixel to be blurred, and C indicates an appropriate constant. A range in which the weight coefficient is set may be limited to the range indicated by equation (4).

x²+y²≦(d/2)² (4)

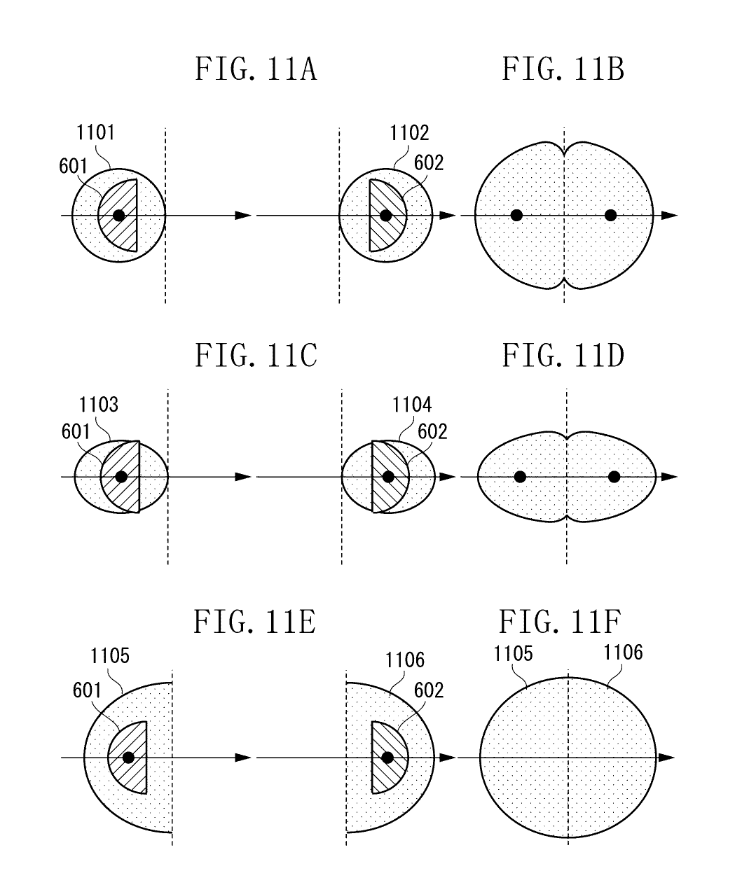

FIGS. 11A, 11B, 11C, 11D, 11E, and 11F illustrate examples of the results of performing the blurring processing. Referring to FIG. 11A, the blurring processing is performed with respect to a point image 601 and a point image 602 so that the respective pixels are blurred in a circular shape as indicated by blur shapes 1101 and 1102. As a result, when both of the point images on which the blurring processing has been performed are combined, the two point images become continuous as illustrated in FIG. 11B, and a feeling of discomfort when the stereoscopic image is viewed as the two-dimensional image is reduced.

However, if the blurring processing is performed so that each pixel is blurred in the circular shape as illustrated in FIGS. 11A and 11B, it becomes necessary to greatly blur the point images for the point images to be continuous. The image is thus greatly changed due to performing the blurring processing. To solve such an issue, the blurring processing may be performed using the coefficient h of the Gaussian filter for blurring each pixel in an oval shape, as indicated by equation (5).

h(x, y)=C exp[−{x²/(d/2)²+y²/(b/2)²}] (5)

In equation (5), b indicates a diameter of a point image distribution 601 in a vertical direction. The diameter of the point image distribution in the vertical direction can be obtained from the value of the parallax for each pixel and an optical design value of the imaging apparatus which has captured the image. The range in which the weight coefficient is set may be limited to the range indicated by the following equation (6).

X≦d/2, y≦b/2 (6)

FIG. 11C illustrates an example of the result obtained in the case where the above described oval-shaped blurring processing is performed. Referring to FIG. 11C, the blurring processing is performed with respect to the point image 601 and the point image 602 so that the respective pixels are blurred in the oval shape as indicated by blur shapes 1103 and 1104. As a result, when both of the point images on which the blurring processing has been performed are combined, the point image illustrated in FIG. 11D is obtained, and the change in the shape of the point images from before performing the blurring processing is reduced.

In the examples illustrated in FIGS. 11B and 11D, corners of joint portions of the right and left point images are rounded, so that the shape of the combined point image is not an ideal circular shape or oval shape. To solve such an issue, other blur shapes may be used for performing the blurring processing. For example, the weight coefficients for blurring each pixel in a semicircular shape as illustrated in FIG. 11E may be set. In such a case, the shape of the combined point image becomes circular as illustrated in FIG. 11F, and the stereoscopic image which is more naturally viewable as the two-dimensional image can be generated. Such weight coefficients can be set by limiting the region for setting the weight coefficients to a semicircular region.

In step S905, the blurring unit 704 uses the weight coefficient group determined in step S904, performs the blurring processing on the pixel selected in step S902, and generates the pixel value. The blurring unit 704 then adds the generated pixel value to the pixel value of the output image data and updates the output image data. The pixel values of all pixels are stored as 0 as initial values of the output image data.

In step S906, the blurring unit 704 determines whether all of the pixels in the image data selected in step S901 has been referred to. If the blurring unit 704 determines that all of the pixels in the image data has been referred to (YES in step S906), the process proceeds to step S907. If the blurring unit 704 determines that not all of the pixels in the image data has been referred to (NO in step S906), the process returns to step S902, and the blurring unit 704 selects a new pixel to be blurred and performs the blurring processing.

In step S907, the blurring unit 704 determines whether the blurring processing has been performed on all viewpoint images of the input image data. If the blurring unit 704 determines that the blurring processing has been performed on all images (YES in step S907), the process proceeds to step S908. If the blurring unit 704 determines that the blurring processing has not been performed on all images (NO in step S907), the process returns to step S901, and the blurring unit 704 selects the image which has not yet been processed as the image subject to the blurring processing. In step S908, the blurring unit 704 outputs the image data, on which the blurring processing has been completed, to the generation unit 905, and the process ends.

The process performed by the blurring unit 704 is as described above. According to the above-described process, natural blurring can be added according to the parallax of each pixel in the right and left viewpoint images on which the parallax enlargement process has been performed. As a result, the feeling of discomfort of the viewer when the stereoscopic image is viewed as the two-dimensional image can be reduced.

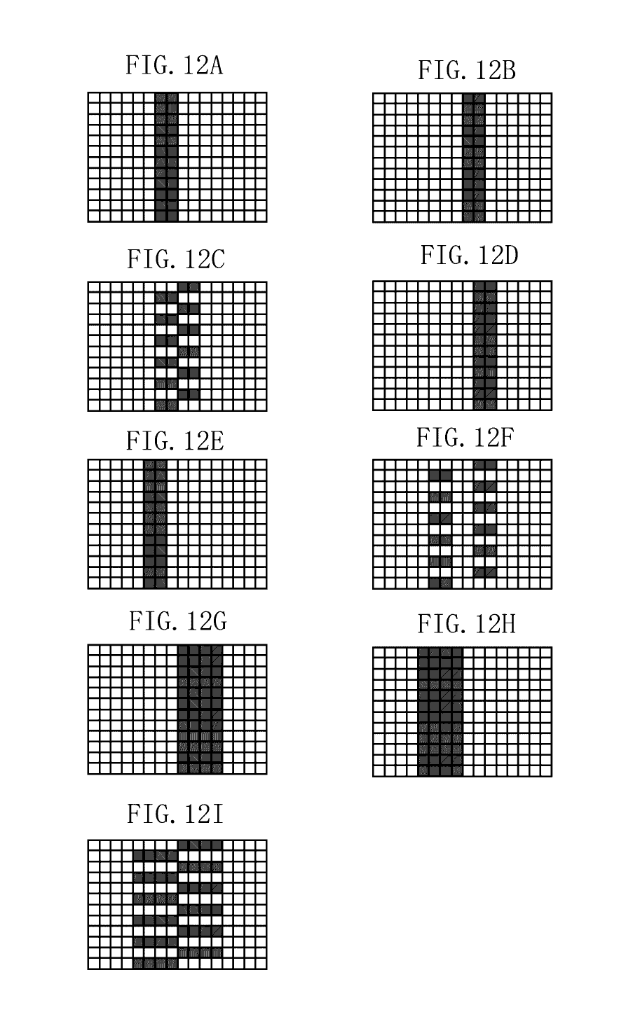

FIGS. 12A, 12B, 12C, 12D, 12E, 12F, 12G, 12H, and 12I illustrate examples in the case where the present exemplary embodiment is applied when displaying the stereoscopic image generated using the line-by-line method on a display device. FIGS. 12A, 12B, and 12C illustrate images on which the parallax enlargement process and the process according to the present exemplary embodiment have not been performed. More specifically, FIG. 12A illustrates a right viewpoint image, FIG. 12B illustrates a left viewpoint image, and FIG. 12C illustrates a stereoscopic image generated from the right and left viewpoint images. Since there is continuity between vertical lines illustrated in FIGS. 12A and 12B, a user viewing the stereoscopic image illustrated in FIG. 12C can recognize the displayed image as one vertical line even when viewing without the 3D glasses.

On the other hand, FIGS. 12D, 12E, and 12F illustrate images obtained by performing the parallax enlargement process and not performing the blurring processing on the right and left viewpoint images. More specifically, FIG. 12D illustrates a right viewpoint image, FIG. 12E illustrates a left viewpoint image, and FIG. 12F illustrates a stereoscopic image generated from the right and left viewpoint images. Since there is no continuity between the vertical lines illustrated in FIGS. 12D and 12E, a gap is generated between the vertical lines in the stereoscopic image illustrated in FIG. 12F. As a result, the user can not recognize the displayed image as one vertical line.

FIGS. 12G, 12H, and 12I illustrate images obtained by performing both the parallax enlargement process and the blurring processing according to the present exemplary embodiment. More specifically, FIG. 12G illustrates a right viewpoint image, FIG. 12H illustrates a left viewpoint image, and FIG. 12I illustrates a stereoscopic image generated from the right and left viewpoint images. By performing the blurring processing according to the present exemplary embodiment, the continuity of the vertical lines between the right and left viewpoint images is recovered, so that the user can recognize the displayed image as one vertical line in the stereoscopic image illustrated in FIG. 12I.

According to the present exemplary embodiment, the blurring unit 704 functions as an obtaining unit configured to obtain multi-viewpoint image data indicating a plurality of images when the same object is viewed from different viewpoints. Further, according to the present exemplary embodiment, the blurring unit 704 also functions as a processing unit for performing, on the multi-viewpoint image data, the blurring processing according to the magnitude of a parallax between the plurality of images. Furthermore, the generation unit 705 functions as a generation unit configured to generate, using the multi-viewpoint image data on which the processing unit has performed the blurring processing, stereoscopic image data to be used for stereoscopic vision of the object. Moreover, the parallax enlargement unit 703 functions as a parallax enlargement unit configured to obtain parallax information indicating a magnitude of a parallax between the plurality of images for each pixel in the plurality of images.

According to the first exemplary embodiment as described above, the blurring processing is performed on the image in which the parallax between the right and left viewpoint images obtained by the plenoptic camera has been enlarged. As a result, the stereoscopic image which can be viewed as the two-dimensional image with little feeling of discomfort is generated. According to a second exemplary embodiment, the blurring processing is performed on the image on the right and left viewpoint images obtained by the stereo camera for generating the stereoscopic image, so that the two-dimensional image is viewable with little feeling of discomfort. Since the contents of the basic process are similar to those according to the first exemplary embodiment, the differences from the first exemplary embodiment will be described below.

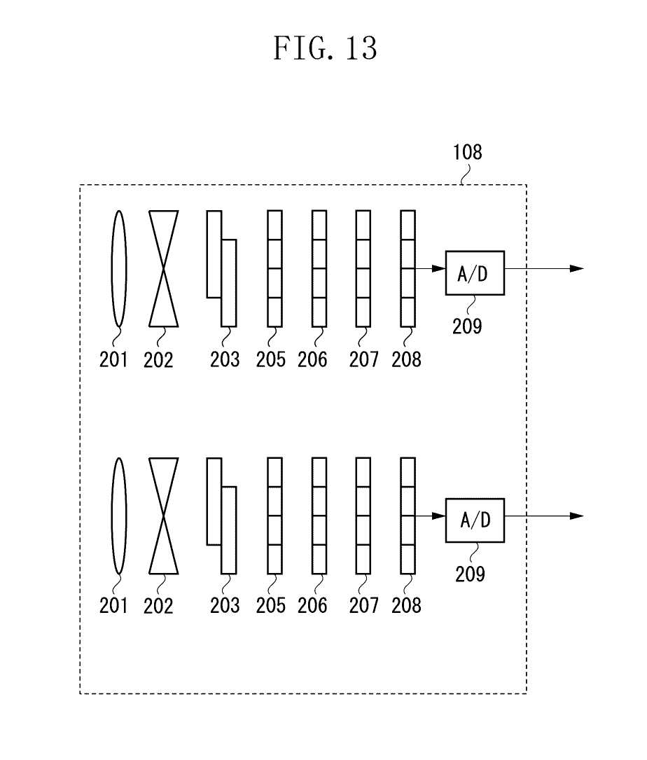

FIG. 13 illustrates an internal configuration of the imaging apparatus 108 (i.e., the stereo camera) according to the second exemplary embodiment. Referring to FIG. 13, the imaging apparatus 108 according to the second exemplary embodiment includes two imaging units which are different from the imaging unit according to the first exemplary embodiment in that the microlens array 204 has been removed. The imaging apparatus 108 can capture and obtain the right and left viewpoint images each having a parallax.

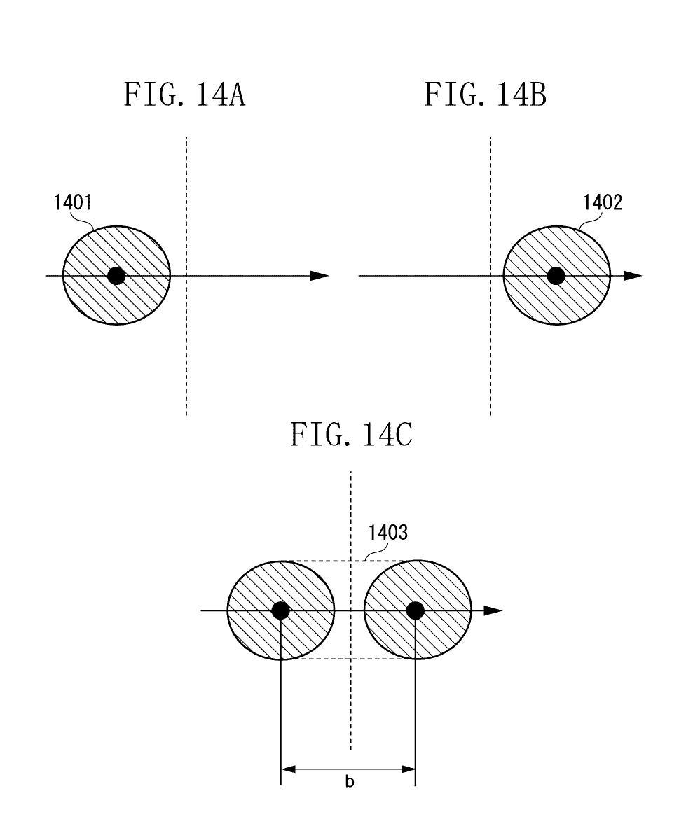

FIGS. 14A, 14B, and 14C are schematic diagrams illustrating one point image distribution captured by the imaging apparatus 108 according to the second exemplary embodiment. More specifically, FIG. 14A illustrates a point image distribution of the right viewpoint image, and FIG. 14B illustrates a point image distribution of the left viewpoint image. Further, FIG. 14C illustrates a point distribution obtained by combining a point image distribution 1401 of the right viewpoint image and a point image distribution 1402 of the left viewpoint image. Referring to FIG. 14C, the imaging apparatus 108 (i.e., the stereo camera) according to the second exemplary embodiment captures each point image via different optical systems independent from each other. In other words, since the apertures of the two imaging units are not continuous, there is no continuity among the point images of the right and left viewpoint images even when the parallax enlargement process has not been performed. As a result, if the stereoscopic image generated from the captured right and left viewpoint images is viewed as the two-dimensional image, the point image corresponding to one object point is perceived to be separated into two. The viewer thus views the image with a feeling of discomfort. To solve such an issue, the right and left viewpoint images are blurred by performing the blurring processing according to the first exemplary embodiment. The stereoscopic image which can be viewed as the two-dimensional image with little feeling of discomfort can then be generated. According to the second exemplary embodiment, there is no continuity among the point images of the right and left viewpoint images captured by the imaging apparatus 108 even when the parallax enlargement process has not been performed. The parallax enlargement process of step S802 may thus be omitted according to the second exemplary embodiment.

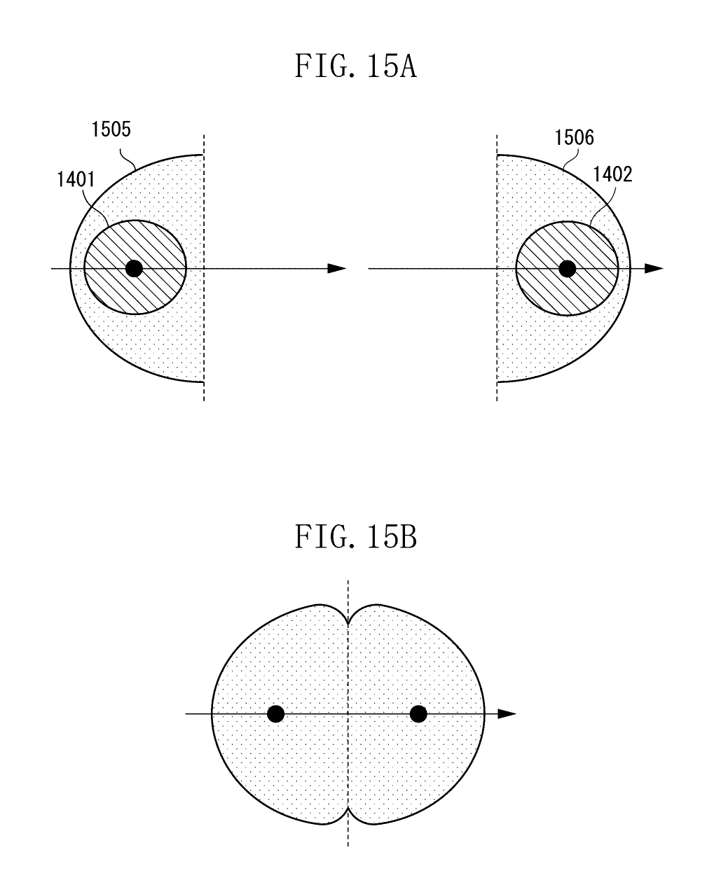

FIGS. 15A and 15B illustrate examples of the blurring processing performed according to the second exemplary embodiment. More specifically, FIG. 15A illustrates an example in which the process for blurring each of the point images of the right and left viewpoint images in the semicircular shape has been performed. FIG. 15B illustrates an example of the point image obtained by combining the point images on which the blurring processing has been performed. As described above, the feeling of discomfort when the stereoscopic image is viewed as the two-dimensional image can be reduced even in the case where the blurring processing is performed on the right and left viewpoint images captured using the stereo camera. The shape of the point image on which the blurring processing has been performed depends on both the shape of the point image on which the blurring processing has not yet been performed and the shape of the weight coefficient group used in performing the blurring processing. It is thus desirable to determine the shape of the weight coefficient group so that the shape of the point image on which the blurring processing has been performed becomes close to the semicircular shape.

The present disclosure is not limited to the above-described exemplary embodiments. For example, according to the above-described exemplary embodiments, the example in which the stereoscopic image is generated using the left viewpoint image corresponding to a left human eye and the right viewpoint image corresponding to a right human eye. However, the stereoscopic image may be generated using the images of a larger number of viewpoints. For example, the stereoscopic image may be generated from four images obtained by combining two pairs of right and left viewpoint images in which magnitudes of parallaxes are different. As a result, viewers having different widths between both eyes can perceive the stereoscopic image at the same time. Further, the present disclosure is applicable to a case where the stereoscopic image is generated using the images of upper and lower viewpoints along with the right and left viewpoint images. In such a case, the stereoscopic image can be perceived from a different angle. Furthermore, the present disclosure is applicable to a case where the right and left viewpoint images are generated by combining the images of more than two viewpoints, or the right and left viewpoint images are selected from the images of more than two viewpoints. In such a case, the plenoptic camera having a larger number of divisions of the viewpoint or a multi-lens camera having three or more cameras may be used.

According to the present disclosure, the feeling of discomfort in the case where the stereoscopic image is viewed as the two-dimensional image can be reduced.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2015-110214, filed May 29, 2015, which is hereby incorporated by reference herein in its entirety.

What is claimed is:

1. An image processing apparatus comprising at least one processor coupled to at least one memory, the at least one processor being programmed to:
obtain multi-viewpoint image data indicating a plurality of images acquired in a case where the same object is viewed from different viewpoints;
perform, on the multi-viewpoint image data, blurring processing which increases a size of blur of the plurality of images according to a magnitude of a parallax between the plurality of images; and
generate, using the multi-viewpoint image data on which the blurring processing has been performed, stereoscopic image data used for stereoscopic vision of the object.

2. The image processing apparatus according to claim 1,
wherein the multi-viewpoint image data includes a right viewpoint image corresponding to a viewpoint of a right human eye and a left viewpoint image corresponding to a viewpoint of a left human eye, and
wherein the stereoscopic image data is image data used for the stereoscopic vision by a right human eye viewing the right viewpoint image and a human left eye viewing the left viewpoint image.

3. The image processing apparatus according to claim 1, wherein the blurring processing is performed for allocating for each pixel in an image subject to the blurring processing a pixel value of the pixel to a plurality of pixels including the pixel at a predetermined ratio and for outputting an image in which the allocated pixel values for each pixel have been added as an image on which the blurring processing has been performed.

4. The image processing apparatus according to claim 3, wherein the processing unit allocates the pixel value to a pixel at a smaller ratio as a distance from the pixel subject to the blurring processing becomes larger.

5. The image processing apparatus according to claim 3, wherein the at least one processor is further programmed to allocate the pixel value of the pixel subject to the blurring processing to a wider range as a parallax between the plurality of images with respect to the pixel subject to the blurring processing becomes larger.

6. The image processing apparatus according to claim 3, wherein the at least one processor is further programmed to allocate the pixel value of the pixel subject to the blurring processing to a semicircular region including the pixel subject to the blurring processing at a predetermined ratio.

7. The image processing apparatus according to claim 1,
wherein the at least one processor is further programmed to obtain parallax information indicating the magnitude of the parallax between the plurality of images for each pixel in the plurality of images, and
to perform the blurring processing based on the obtained parallax information.

8. The image processing apparatus according to claim 1, wherein the multi-viewpoint image data is an image on which a parallax enlargement process for enlarging a parallax between a plurality of images has been performed, the plurality of images being acquired in a case where the object captured by a plenoptic camera is viewed from different viewpoints.

9. The image processing apparatus according to claim 1, wherein the multi-viewpoint image data is data indicating a plurality of images captured by a plurality of imaging units each having an independent optical system.

10. An image processing method comprising:
obtaining multi-viewpoint image data indicating a plurality of images acquired in a case where the same object is viewed from different viewpoints;
performing, on the multi-viewpoint image data, blurring processing which increases a size of blur of the plurality of images according to a magnitude of a parallax between the plurality of images; and
generating, using the multi-viewpoint image data on which the blurring processing has been performed, stereoscopic image data used for stereoscopic vision of the object.

11. A non-transitory computer-readable storage medium which stores a program to cause a computer to execute a method comprising:
obtaining multi-viewpoint image data indicating a plurality of images acquired in a case where the same object is viewed from different viewpoints;
performing, on the multi-viewpoint image data, blurring processing which increases a size of blur of the plurality of images according to a magnitude of a parallax between the plurality of images; and
generating, using the multi-viewpoint image data on which the blurring processing has been performed, stereoscopic image data used for stereoscopic vision of the object.
